(19) United States
(12) Patent Application Publication
(10) Pub. No.: US 2022/0027677 A1
(43) Pub. Date: Jan. 27, 2022

(54) INFORMATION PROCESSING DEVICE, INFORMATION PROCESSING METHOD, AND STORAGE MEDIUM

(71) Applicant: NEC Corporation, Minato-ku, Tokyo (JP)

(72) Inventor: Kazuya KAKIZAKI, Tokyo (JP)

(73) Assignee: NEC Corporation, Minato-ku, Tokyo (JP)

(21) Appl. No.: 17/297,236

(22) PCT Filed: Dec. 12, 2018
(86) PCT No.: PCT/JP2018/045738

§ 371 Date: May 26, 2021

(51) Int. Cl. G06K 9/62; G06K 9/00

(52) U.S. Cl. CPC G06K 9/6262; G06K 9/6255; G06K 9/00288; G06K 9/6215

(57) ABSTRACT

An information processing device includes a sample candidate generation unit that generates a sample candidate to be authenticated to belong to a target class that is a class inducing erroneous authentication, from source data belonging to a class other than the target class, on the basis of a similarity degree with data belonging to the target class in a template that is data registered in advance, and a similarity degree with data not belonging to the target class in the template.

### TECHNICAL FIELD

The present invention relates to an information processing device, an information processing method, and a storage medium.

### BACKGROUND ART

A model learned by deep learning involves vulnerability. For example, there is a problem that when an adversarial example (hereinafter referred to as AX) that is an artificial sample precisely created so as to deceive a learned model is used, the AX induces malfunction that is not expected by the designer during training.

As a document describing a method of generating an AX, Non-Patent Literature 1 is known. Non-Patent Literature 1 describes a method of generating an AX in which a similarity degree between target data xₜ and the AX becomes maximum, on the basis of the similarity degree with the target data xₜ.

Non-Patent Literature 1: Sara Sabour, Yanshuai Cao, Fartash Faghri, David J. Fleetl, “ADVERSARIAL MANIPULATION OF DEEP REPRESENTATIONS”, International Conference on Learning Representations (ICLR) 2016

### SUMMARY

In the art described in Non-Patent Literature 1, an AX is generated based on the similarity degree with the target data xt, and no class other than the class to which the target data belongs is taken into consideration. Therefore, by the method described in Non-Patent Literature 1, it is not always the case where the similarity degree with respect to the class to which the target data, calculated by the generated AX, belongs (target class) has the maximum value among the similarities with respect to the classes in the template that is data registered in advance. As a result, in the case of an AX generated by the method described in Non-Patent Literature 1, there is a possibility that it is authorized as a class other than the target class.

As described above, in the case of the art described in Non-Patent Literature 1, since similarities with respect to data belonging to classes other than the class to which the target data belongs are not taken into consideration at all, there is a problem that an appropriate AX may not be able to be generated. Therefore, an object to the present invention is to provide an information processing device, an information processing method, and a storage medium that can solve the problem that an appropriate AX may not be generated.

In order to achieve the object, an information processing device according to one aspect of the present invention is configured to include

a sample candidate generation unit that generates a sample candidate to be authenticated to belong to a target class that is a class inducing erroneous authentication, from source data belonging to a class other than the target class, on the basis of a similarity degree with data belonging to the target class in a template that is data registered in advance and a similarity degree with data not belonging to the target class in the template.

Further, an information processing method according to another aspect of the present invention is configured to include,

by an information processing device, generating a sample candidate to be authenticated to belong to a target class that is a class inducing erroneous authentication, from source data belonging to a class other than the target class, on the basis of a similarity degree with data belonging to the target class in a template that is data registered in advance and a similarity degree with data not belonging to the target class in the template.

Further, a storage medium according to another aspect of the present invention is a computer-readable storage medium storing a program for realizing, on an information processing device,

a sample candidate generation unit that generates a sample candidate to be authenticated to belong to a target class that is a class inducing erroneous authentication, from source data belonging to a class other than the target class, on the basis of a similarity degree with data belonging to the target class in a template that is data registered in advance and a similarity degree with data not belonging to the target class in the template.

With the configurations described above, the present invention is able to provide an information processing device, an information processing method, and a storage medium that can solve the problem that a suitable AX may not be generated.

### BRIEF DESCRIPTION OF DRAWINGS

FIG. 1 illustrates an example of a feature space calculated by a deep learning model.

FIG. 2 is a block diagram illustrating an exemplary configuration of an AX generation device according to a first exemplary embodiment of the present invention.

FIG. 3 is a flowchart showing an exemplary operation of an AX generation device described in the first exemplary embodiment of the present invention.

FIG. 4 is a block diagram illustrating an exemplary configuration of a risk assessment device according to a second exemplary embodiment of the present invention.

FIG. 5 is a flowchart showing an exemplary operation of the risk assessment device described in the second exemplary embodiment of the present invention.

FIG. 6 illustrates an exemplary hardware configuration of a computer (information processing device) by which the first exemplary embodiment and the second exemplary embodiment of the present invention can be realized.

FIG. 7 is a block diagram illustrating an exemplary configuration of an information processing device according to a third exemplary embodiment of the present invention.

### EXEMPLARY EMBODIMENTS

Hereinafter, exemplary embodiments of the present invention will be described with reference to the drawings.

Note that each drawing describes an exemplary embodiment of the present invention. However, the present invention is not limited to those described in the drawings. Further, the same components in the drawings are denoted by the same reference numerals, and the repetitive description may be omitted. Furthermore, in the drawings used in the below description, the configurations of parts not related to the description of the present invention may be omitted, and may not be shown on the drawings.

### First Exemplary Embodiment

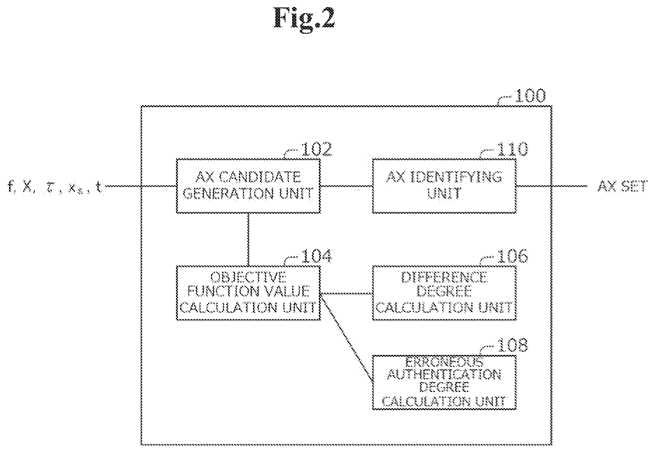

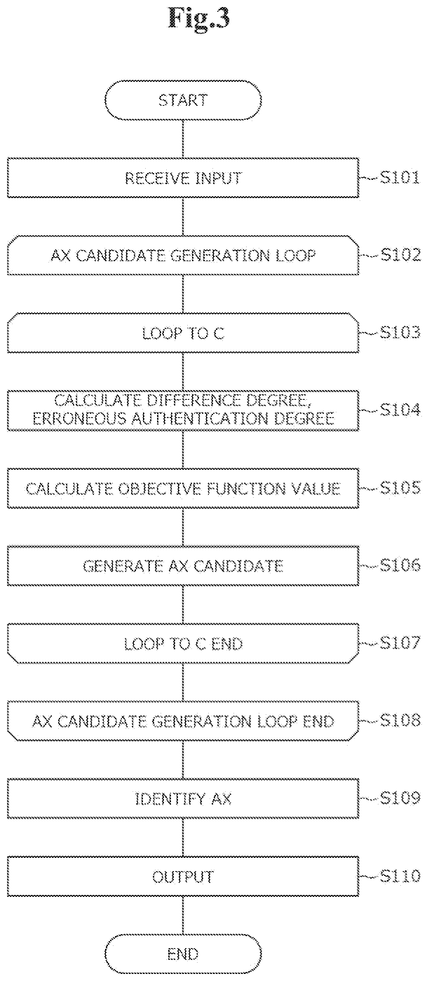

A first exemplary embodiment of the present invention will be described with reference to FIGS. 2 and 3. FIG. 2 is a block diagram illustrating an exemplary configuration of an AX generation device 100. FIG. 3 is a flowchart illustrating an exemplary operation of the AX generation device 100.

The first exemplary embodiment of the present invention describes the AX generation device 100 that generates an adversarial example (AX) that is a sample created so as to deceive a learned model. As described below, the AX generation device 100 described in the present embodiment generates a plurality of AX candidates on the basis of the similarity degree with data belonging to the target class in the template, and the similarity degree with data not belonging to the target class. In other words, the AX generation device 100 generates AX candidates while considering not only data belonging to the target class but also data not belonging to the target class. With this configuration, the AX generation device 100 can generate an appropriate AX while considering data not belonging to the target class.

For example, in Non-Patent Literature 1, by solving an optimization problem like Expression 1 provided below, an AX x_{adv} in which the difference between source data xₛ and the AX x_{adv} has a value smaller than δ and the similarity degree between the feature amounts of target data xₜ and the AX x_{adv} is maximum is generated.

$${argmax}_{{x}_{adv}} sim ( {x}_{adv} , {x}_{t} ) \\ subject to diff ( {x}_{s} , {x}_{adv} ) < δ \qquad [ Expression 1 ]$$

Here, xₛ represents source data, xₜ represents target data, and f represents a deep learning model that outputs a feature amount. Further, δ represents a parameter that determines the allowable degree of the difference between the source data xₛ and the AX x_{adv}, and δ>0 is satisfied. Furthermore, sim( ) is a function that computes the similarity degree between the target data xₜ and the AX x_{adv}, and diff( ) is a function that computes the magnitude of the difference between the source data xₛ and the AX x_{adv}.

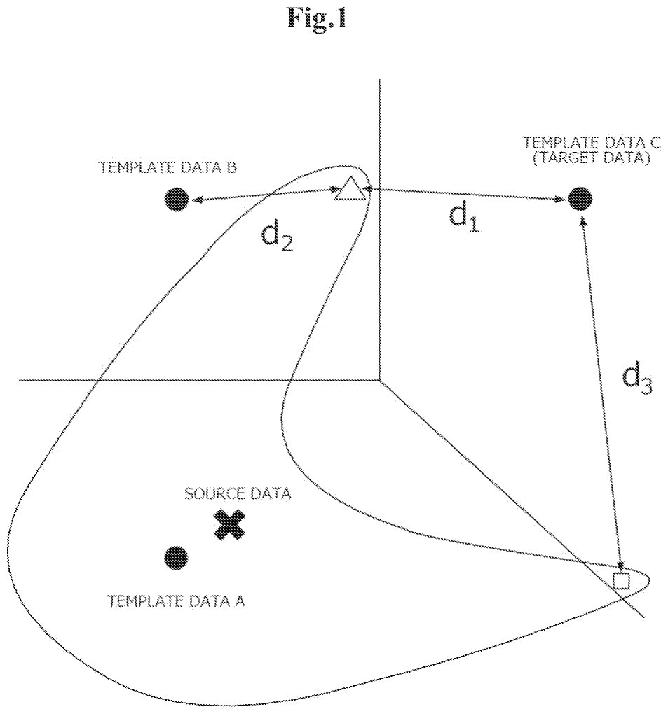

In the art described in Non-Patent Literature 1, there is a possibility that the case illustrated in FIG. 1 may be caused. FIG. 1 illustrates an example of the case where an appropriate AX cannot be generated by the art described in Non-Patent Literature 1. In the example of FIG. 1, as an index of a similarity degree, a value obtained by multiplying L2 distance by −1 is used. That is, Expression 2. As the L2 distance between two points is shorter, the similarity degree is higher.

sim(x, x′)=∥x−x′∥₂ [Expression 2]

In FIG. 1, a feature space calculated according to the deep learning model f is shown. A mark “x” represents the source data that is the source of generating the AX, and a mark “∘” represents the position of the feature amount of the template data. Further, a line in FIG. 1 represents the boundary of determining authentication.

In the example of FIG. 1, generating an AX by designating the target data as template data C in considered. In other words, it is considered to generate an AX in which erroneous authentication succeeds with respect to the template data C, by using the source data authenticated as the class of the template data A as the source. At that time, the curve in FIG. 1 shows the search range of the AX in the optimization problem of Non-Patent Literature 1. The search range shown by the curve is limited by a constraint expression diff(xₛ,x_{adv})<δ. That is, the optimization problem in Non-Patent Literature 1 is equivalent to a problem of finding a point having the closest distance to the template data C in the curve of FIG. 1.

A solution (a point having the closest distance) obtained by solving the optimization problem of Non-Patent Literature 1 is shown as a triangle mark in FIG. 1. However, since a relationship of d₂<d₁ is established for the triangle mark, it is authenticated to be in a class of template data B. Therefore, the triangle mark that is a solution obtained by solving the optimization problem of Non-Patent Literature 1 is not the AX that induces erroneous authentication to the objective target class C. On the other hand, the square mark in FIG. 1 shows an AX in which erroneous authentication succeeds with respect to the template data C. However, since d₁<d₃ is established, it cannot be found by the art described in Non-Patent Literature 1. As described above, in the case of the art described in Non-Patent Literature 1, although there is an AX in which erroneous authentication succeeds with respect to the template data C, since d₁<d₃ is established, such an AX cannot be found correctly.

For example, as described above, in the case of the art of Non-Patent Literature 1, although there is an AX in which erroneous authentication to the target class succeeds, there is a possibility that an AX in which erroneous authentication succeeds cannot be generated. The AX generation device 100 described in the present embodiment generates an AX while considering data not belonging to the target class, as described above. Therefore, it is possible to realize a method of generating an AX in which the problem involved in Non-Patent Literature 1 has been solved. That is, according to the AX generation device 100 described in the present embodiment, since data not belonging to the target class is also considered, for example, it is possible to generate an AX indicated as the square mark rather than the triangle mark of FIG. 1. Hereinafter, an example of a specific configuration of the AX generation device 100 will be described.

The AX generation device 100 is an information processing device that receives inputs such as the deep learning model f, a template X, a threshold τ, the source data xₛ, the target class t, and the like, and performs predetermined processing to thereby generate an AX from the source data xₛ. For example, the AX generation device 100 receives the deep learning model f, the template X, the threshold τ, the source data xₛ, the target class t, and the like from an external device or a network. Then, the AX generation device 100 performs processing corresponding to the received inputs to generate an AX.

Here, the deep learning model f is a model that has been learned in advance using deep learning and outputs a feature amount with respect to an input image. The feature amount is, for example, a d-dimensional vector having an actual value as an element. Note that d takes any value. The template X is a set X={x₁, . . . , xₙ} having n pieces of data registered for authentication when the deep learning model f is operated. Here, the n pieces of data x₁, . . . , xₙ have different classes respectively, and xᵢ represent data belonging to a class i. For example, when the authentication task is face authentication, the template X is configured of face images of n persons, one for each. Note that n takes any value. For example, as described above, the template X includes one or more pieces of data registered in advance. The threshold τ is a value used for comparison with the feature similarity degree for authentication. As described below, the threshold τ is used for identifying an AX in which erroneous authentication with respect to the target class t has succeeded, among the generated AX candidates. This means that the threshold τ is used to select an AX in which erroneous authentication with respect to the target class t succeeds, from among the generated AX candidates. The source data xₛ is data used as a source of generating an AX. The source data xₛ belongs to a class among the classes to which the pieces of data included in the template X belong. The target class t is an erroneous authentication destination class for generating an AX. As the target class t, a class different from the class to which the source data xₛ belongs is selected (that is, it can be said that the source data xₛ belongs to a class other than the target class t). Further, as the target class t, a class that is the same as the class to which any piece of the data x₁, . . . , xₙ in the template X belongs is designated. As described above, the target class t is a class to which erroneous authentication may be caused, among the classes to which the pieces of data included in the template belong.

Note that the AX generation device 100 may store some of the information illustrated above in advance. That is, the AX generation device 100 may be configured to receive at least one of the deep learning model f, the template X, the threshold τ, the source data xₛ and the target class t as an input.

FIG. 2 illustrates an exemplary configuration of the AX generation device 100. Referring to FIG. 2, the AX generation device 100 includes, for example, an AX candidate generation unit 102 (sample candidate generation unit), an objective function value calculation unit 104, a difference degree calculation unit 106, an erroneous authentication degree calculation unit 108, and an AX identifying unit 110 (sample identifying unit).

For example, the AX generation device 100 includes an arithmetic unit such as a central processing unit (CPU) and a storage unit. For example, in the AX generation device 100, the arithmetic unit executes a program stored in the storage unit, whereby the various processing units described above are implemented.

The AX candidate generation unit 102 uses the deep learning model f, the template X, the source data xₛ, and the target class t, input thereto, to generate AX candidates (sample candidates) in which erroneous authentication is induced as the target class t, in the process of solving the optimization problem expressed by Expression 3 provided below.

$${argmin}_{{x}_{adv}} \{ {max}_{{x}_{i} ∈ X \text{:} i \neq t} \{ Sim ( f ( {x}_{adv} ) , f ( {x}_{i} ) ) \} - Sim ( f ( {x}_{adv} ) , d ( {x}_{t} ) ) \} \\ subject to Diff ( {x}_{s} , {x}_{adv} ) < δ \qquad [ Expression 3 ]$$

Here, xₛ represents source data, t represents a target class, and f represents a deep learning model that outputs a feature amount. Further, δ represents a parameter that determines the allowable degree of the difference between the source data xₛ and the AX x_{adv}. Further, sim is a function used to compute the similarity degree for two feature amounts extracted at the time of authentication, and Diff is a function used to compute the magnitude of the difference.

A solution of the optimization problem expressed by Expression 3 is a point that has a large similarity degree with data belonging to the target class in the template and has a small similarity degree with data not belonging to the target class. Therefore, in other words, it can be said that the AX candidate generation unit 102 generates AX candidates in the process of solving the optimization problem of obtaining a value having a large similarity degree with data belonging to the target class in the template and having a small similarity degree with data not belonging to the target class. Further, in the case of Expression 3, when there is an AX that induces erroneous authentication to the target class t, it is ensured that the AX is the solution of the optimization problem expressed in Expression 3.

In the optimization problem with restriction as expressed by Expression 3, for example, the solution is searched by transforming it to a minimization problem of an objective function with use of Lagrange multiplier method. For example, the AX candidate generation unit 102 searches for the solution by using the objective function expressed by Expression 4 that is computed by the objective function value calculation unit 104 to solve the optimization problem expressed by Expression 3.

J(f, X, xₛ, x_{adv}, t)=Diff(xₛ, x_{adv})+cError(f, X, t, x_{adv}) [Expression 4]

Here, the difference Diff(xₛ,x_{adv}) is a value representing the magnitude of the difference between the source data xₛ and the AX candidate x_{adv}, which means as the value is smaller, the AX candidate x_{adv} has a smaller difference with the source image. Further, an erroneous authentication degree Error(f,X,t,x_{adv}) is a value of a function of minimization in the optimization problem expressed by Expression 3.

The AX candidate generation unit 102 generates AX candidates using the optimization method so as to make both the difference Diff(xₛ,x_{adv}) and the erroneous authentication degree Error(f,X,t,x_{adv}) smaller, that is, make the objective function value J(f,X,x_s,x_{adv},t) smaller. Note that c in Expression 4 represents a parameter corresponding to δ in the optimization problem expressed by Expression 3. In the optimization problem expressed by Expression 3, the search range of AX is determined by δ. In order to generate an AX having a smaller difference from the source data after erroneous authentication to the target class is induced, it is necessary to solve the optimization problem expressed by Expression 3 a plurality of times by changing the value of δ. In other words, the AX candidate generation unit 102 needs to search for the solution using a plurality of objective functions having different c values.

The AX candidate generation unit 102 searches for the solution using objective functions with respect to a plurality of c values. Specifically, the AX candidate generation unit 102 determines an initial point expressed by Expression 5 for each c value (in the present embodiment, the method of determining the initial point is not limited particularly). Then, the AX candidate generation unit 102 generates AX candidates by sequentially changing the initial point such that the value of the objective function becomes smaller. Note that the parameter c may be one unique to the AX generation device 100, or may be received as an input from the outside. Further, the parameter c may be determined efficiently by using a method such as binary search.

x_{adv}⁰ [Expression 5]

As described above, the AX candidate generation unit 102 searches for AX candidates by using a gradient-based optimization method. The gradient-based optimization method is a method in which an input initial point is determined, the input is gradually changed so as to make the value of the objective function smaller on the basis of gradient information of the objective function, whereby an input that makes the value of the objective function sufficiently small is searched. In the AX candidate generation unit 102, Expression 6 is sequentially solved by changing m times at maximum from each of the initial points (Expression 5) with respect to the objective functions determined by a plurality of parameters c, and the solutions are used as AX candidates. Here, m may be a variable unique to the AX generation device 100, or may be received as an input from the outside. Examples of gradient-based optimization method include Adagrad, Adam, and the like. The AX candidate generation unit 102 may use any optimization method if it is a gradient-based method.

x_{adv}ⁱ(0<i<m) [Expression 6]

Assuming that |c| is the number of the parameters c used in the AX candidate generation unit 102, the AX candidate generation unit 102 finally generates |c|×m pieces of AX candidates. As described below, in the case of the present embodiment, by the AX identifying unit 110, an AX set to be output is finally determined from the AX candidates generated by the AX candidate generation unit 102.

In order to solve the optimization problem expressed by Expression 3, the objective function value calculation unit 104 calculates an objective function value expressed by Expression 10 in the AX candidate as expressed by Expression 9, using the difference degree expressed by Expression 7 obtained by the difference degree calculation unit 106 and the erroneous authentication degree expressed by Expression 8 calculated by the erroneous authentication degree calculation unit 108.

Diff(xₛ, x_{adv}ⁱ) [Expression 7]

Error(f, X, t, x_{adv}ⁱ) [Expression 8]

x_{adv}ⁱ [Expression 9]

J(f, X, xₛ, x_{adv}ⁱ, t) [Expression 10]

The difference degree calculation unit 106 calculates the difference degree (refer to Expression 7) between the source data xₛ and the AX candidate expressed by Expression 9. As described above, the difference degree is a value indicating the magnitude of the difference between the source data xₛ and the AX candidate expressed by Expression 9. For example, the difference degree indicates that as the value is smaller, the difference is smaller. An example of a difference degree used by the difference degree calculation unit 106 is L2 distance. When L2 distance is used as a difference, the difference degree calculation unit 106 calculates the difference degree expressed by Expression 7 by solving the equation expressed by Expression 11 provided below, for example.

Diff(xₛ, x_{adv}ⁱ)=∥xₛ, −x_{adv}ⁱ∥₂ [Expression 11]

Note that the difference degree calculation unit 106 may be configured to calculate the difference degree using a method other than that described above. For example, the difference degree calculation unit 106 may be configured to calculate the difference degree by multiplying cos similarity degree by −1.

The erroneous authentication degree calculation unit 108 calculates the erroneous authentication degree expressed by Expression 8 in the AX candidate expressed by Expression 9. As described above, the erroneous authentication degree expressed by Expression 8 is a function for minimization in the optimization problem expressed by Expression 3. For example, the erroneous authentication degree calculation unit 108 calculates the erroneous authentication degree expressed by Expression 8, by solving the equation expressed by Expression 12 provided below.

$$Error ( f , X , t , {x}_{adv}^{i} ) = {max}_{{x}_{i} ∈ X \text{:} i \neq t} \{ Sim ( f ( {x}_{adv}^{i} ) , f ( {x}_{i} ) ) \} - Sim ( f ( {x}_{adv}^{i} ) , f ( {x}_{i} ) ) \qquad [ Expression 12 ]$$

Here, Sim represents a function used for calculating the similarity degree with respect to two feature amounts extracted at the time of authentication. As Sim, cos similarity degree or one obtained by multiplying L2 distance by −1 may be used, for example.

The AX identifying unit 110 identifying an AX in which erroneous authentication to the target class t has succeeded, among the AX candidates generated by the AX candidate generation unit 102. As described above, the AX candidate generation unit 102 generates AX candidates of the number corresponding to the parameters c. The AX candidate generation unit 102 selects an AX in which erroneous authentication to the target class t has succeeded, from among the generated AX candidates. This means that the AX identifying unit 110 selects an AX that is authenticated to belong to the target class t, from among the generated AX candidates.

For example, the AX identifying unit 110 checks whether or not the value of Expression 13, shown below, is Sim(f(x_{adv}),f(xₜ)) by using the threshold τ to thereby check whether or not the AX candidate x_{adv} has succeeded in erroneous authentication to the target t. For example, when the value of Expression 13 is Sim(f(x_{adv}),f(xₜ)), the AX identifying unit 110 determines that the AX candidate x_{adv} has succeeded in erroneous authentication to the target t. Then, the AX identifying unit 110 selects the AX candidate x_{adv} determined to have succeeded in erroneous authentication to the target t, as an AX that has succeeded in erroneous authentication.

$$max \{ {max}_{{x}_{i} ∈ X} \{ Sim ( f ( {x}_{adv} ) , f ( {x}_{i} ) ) \} , τ \} \qquad [ Expression 13 ]$$

For example, by performing the processing as described above, the AX identifying unit 110 selects an AX set including one or more AXs from among the AX candidates. Thereafter, the AX identifying unit 110 can transmit the selected AX set to the outside.

An exemplary configuration of the AX generation device 100 has been described. As described above, the AX generation device 100 receives the deep learning model f, the template X, the threshold τ, the source data xₛ, the target class t, and the like as inputs. Then, the AX generation device 100 generates a plurality of AX candidates, on the basis of the similarity degree with data belonging to the target class in the template and the similarity degree degree of data not belonging to the target class. Next, an exemplary operation of the AX generation device 100 will be described with reference to FIG. 3.

FIG. 3 is a flowchart illustrating an exemplary operation of the AX generation device 100. Referring to FIG. 3, the AX candidate generation unit 102 receives the deep learning model f, the template X, the threshold τ, the source data xₛ, and the target class t as inputs (step S101).

In order to determine the objective function, the AX candidate generation unit 102 determines the value of the parameter c. Then, the AX candidate generation unit 102 inputs the determined parameter c to the objective function value calculation unit 104 to search for AX candidates. That is, the AX candidate generation unit 102 enters a search loop (step S102). Note that the parameter c may be a predetermined one.

For the parameter c, the AX candidate generation unit 102 determines an initial point expressed by Expression 14. Then, the AX candidate generation unit 102 inputs the determined initial point to the objective function value calculation unit 104 to search for an AX by the optimization method. That is, the AX candidate generation unit 102 enters an optimization loop with respect to the parameter c (step S103).

x_{adv}⁰ [Expression 14]

The objective function value calculation unit 104 uses an input at the i^{th} step (refer to Expression 15) to issue an instruction to calculate the difference degree to the difference degree calculation unit 106, and an instruction to calculate the erroneous authentication degree to the erroneous authentication degree calculation unit 108. Upon receipt of the instructions, the difference degree calculation unit 106 and the erroneous authentication degree calculation unit 108 calculate the difference degree and the erroneous authentication degree with use of the input expressed by Expression 15 (step S104). Then, the difference degree calculation unit 106 and the erroneous authentication degree calculation unit 108 input the calculated values to the objective function value calculation unit 104.

x_{adv}ⁱ [Expression 15]

The objective function value calculation unit 104 receives the difference degree from the difference degree calculation unit 106 and receives the erroneous authentication degree from the erroneous authentication degree calculation unit 108. Then, the objective function value calculation unit 104 calculates the objective function value using the difference degree, the erroneous authentication degree, and the parameter c (step S105). Thereafter, the objective function value calculation unit 104 inputs the calculated value to the AX candidate generation unit 102.

The AX candidate generation unit 102 determines a change in Expression 16 on the basis of the received value of the objective function. Then, the AX candidate generation unit 102 inputs the AX candidate expressed by Expression 16 to the AX identifying unit 110 (step S106).

x_{adv}ⁱ⁺¹ [Expression 16]

The AX generation device 100 repeats the loop processing from step S104 to step S106 m times determined in advance. Then, when changes have been made m times in total from the initial point, the AX generation device 100 leaves the optimization loop for the parameter c (step S107).

The AX generation device 100 repeats the optimization loop to the parameter c as described above the number of times corresponding to the number of parameters c. Then, when the optimization loop related to all of the given parameters c ends, the AX generation device 100 ends the search loop for AX candidates (step S108).

The AX identifying unit 110 identifies an AX in which erroneous authentication has succeeded, among the AX candidates generated by the AX candidate generation unit 102 (step S109). That is, the AX identifying unit 110 selects an AX set including one or more AXs from among the AX candidates. Then, the AX identifying unit 110 can output the selected AX set, to a display device or to an external device or an external network (step S110).

An exemplary operation of the AX generation device 100 has been described.

As described above, the AX generation device 100 includes the AX candidate generation unit 102. With this configuration, the AX candidate generation unit 102 can generate a plurality of AX candidates, on the basis of the similarity degree with data belonging to the target class tin the template X and the similarity degree of data not belonging to the target class t. Consequently, the AX candidate generation unit 102 can generate AX candidates while considering not only data belonging to the target class t but also data not belonging to the target class t. That is, it is possible to generate more appropriate AX candidates by which erroneous authentication can succeed.

Note that the AX generated as described above can be used for performing adversarial training and additional learning for acquiring resistance to attack, for example. Further, the AX can be used for performing risk assessment to be explained in a second exemplary embodiment described below. The generated AX may be used for a purpose other than that described above as an example.

Further, the AX generation device 100 described in the present embodiment can be used for performing biometric authentication on a person on the basis of information such as a face and a fingerprint using a model learned by deep learning, for example. Note that the AX generation device 100 may be utilized in a scene other than that described above as an example.

### Second Exemplary Embodiment

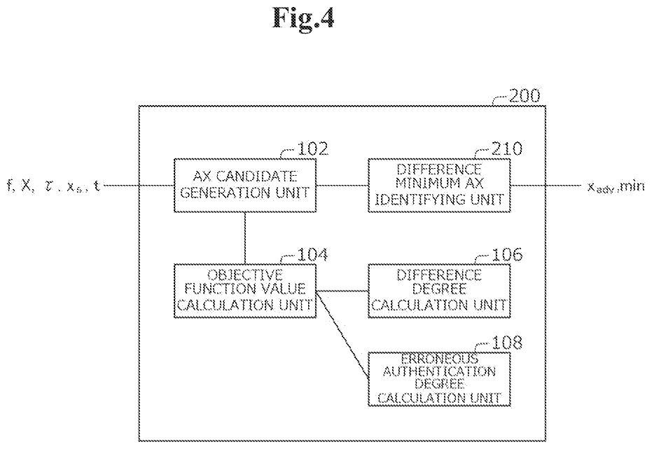

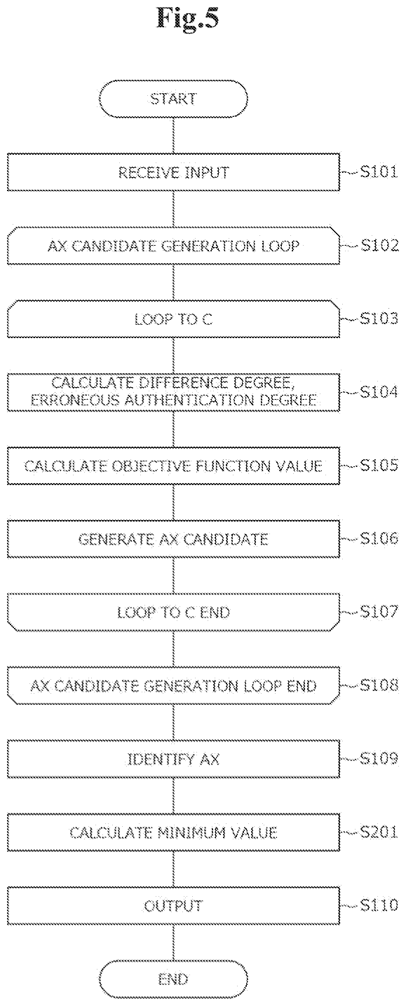

Next, a second exemplary embodiment of the present invention will be described with reference to FIGS. 4 and 5. FIG. 4 is a block diagram illustrating an exemplary configuration of a risk assessment device 200. FIG. 5 is a flowchart showing an exemplary operation of the risk assessment device 200.

In the second exemplary embodiment of the present invention, the risk assessment device 200 that assesses a learned model will be described. In the present embodiment, as a criterion for assessing a risk to the AX of a learned model, a difference degree that is magnitude of the difference between the input (source data) that is the source of generating the AX and the AX will be used. This is because since an AX having a small difference is less likely to be noticed when it is input at the time of operation, compared with the case of an AX having a large difference. Therefore, the risk of operating the learned model increases when there is an AX having a smaller difference.

As described below, the risk assessment device 200 described in the present embodiment has almost similar functions to those held by the AX generation device 100 described in the first exemplary embodiment. Further, the risk assessment device 200 selects an AX on the basis of the difference degree from among the selected AX set. Then, the risk assessment device 200 outputs the selected AX and the difference degree serving as a criterion for assessing the risk.

As described above, the risk assessment device 200 is an information processing device that performs risk assessment of a learned model. FIG. 4 illustrates an exemplary configuration of the risk assessment device 200. Referring to FIG. 4, the risk assessment device 200 includes, for example, the AX candidate generation unit 102, the objective function value calculation unit 104, the difference degree calculation unit 106, the erroneous authentication degree calculation unit 108, and a difference minimum AX identifying unit 210 (sample identifying unit). As described above, similar to the AX generation device 100 described in the first exemplary embodiment, the risk assessment device 200 includes the AX candidate generation unit 102, the objective function value calculation unit 104, the difference degree calculation unit 106, and the erroneous authentication degree calculation unit 108. The configurations of the AX candidate generation unit 102, the objective function value calculation unit 104, the difference degree calculation unit 106, and the erroneous authentication degree calculation unit 108 are similar to those of the AX generation device 100. Therefore, the descriptions thereof are omitted.

For example, the risk assessment device 200 includes an arithmetic unit such as a CPU and a storage unit. For example, in the risk assessment device 200, the arithmetic unit executes a program stored in the storage unit, whereby the various processing units described above are implemented.

Similar to the AX identifying unit 110 included in the AX generation device 100 described in the first exemplary embodiment, the difference minimum AX identifying unit 210 identifies an AX in which erroneous authentication to the target class t has succeeded, among the AX candidates generated by the AX candidate generation unit 102. That is, the difference minimum AX identifying unit 210 selects an AX set including one or more AXs from among the AX candidates.

Further, the difference minimum AX identifying unit 210 compares the difference degrees Diff(xₛ,x_{adv}) between the AXs in the identified AX set. Then, the difference minimum AX identifying unit 210 selects an AX having the minimum difference degrees Diff(xₛ,x_{adv}) from the identified AX set. Then, the difference minimum AX identifying unit 210 can output the selected AX and the minimum difference degree to a display device or to an external device or an external network.

As described above, the difference minimum AX identifying unit 210 is configured to select an AX in which the difference degree becomes the minimum, in addition to the process of identifying the AX set performed by the AX identifying unit 110. Further, the difference minimum AX identifying unit 210 is configured to output the selected AX and the difference degree of the selected AX. Note that the difference minimum AX identifying unit 210 may be configured to output the AX set before selection, along with the above-described information, for example.

Next, an exemplary operation of the risk assessment device 200 will be described with reference to FIG. 5.

FIG. 5 is a flowchart showing an exemplary operation of the risk assessment device 200. As illustrated in FIG. 5, the operation of the risk assessment device 200 up to step S109 is the same as that of the AX generation device 100 described in the first exemplary embodiment. Therefore, the detailed description thereof is omitted.

After identifying the AX in which erroneous authentication has succeeded from the AX candidates generated by the AX candidate generation unit 102 (step S109), the difference minimum AX identifying unit 210 selects the AX in which the difference degree Diff(xs,xadv) becomes minimum from the identified AX set (step S201). Then, the difference minimum AX identifying unit 210 can output the selected AX and the minimum difference degree to the outside (step S110).

As described above, the risk assessment device 200 described in the present embodiment includes the AX candidate generation unit 102 and the difference minimum AX identifying unit 210. With this configuration, the AX candidate generation unit 102 can generate more appropriate AX candidates enabling erroneous authentication to be succeeded. Further, by selecting the AX of the minimum difference degree Diff(xs,xadv) from the identified AX set from which the AX candidates generated by the AX candidate generation unit 102 are selected, the difference minimum AX identifying unit 210 can select an AX that is more appropriate for risk assessment. Thereby, more appropriate risk assessment can be made. In other words, the risk assessment device 200 described in the present embodiment has a function of generating an appropriate AX. Therefore, it is possible to perform risk assessment of a model more appropriately. Thereby, it is possible to more appropriate realize a system for finding vulnerability such as fuzzing in software and performing risk assessment with respect to a learned model, for example.

In the present embodiment, as a criterion for assessing a risk of a learned model, it has been described that the risk assessment device 200 uses a difference degree that is magnitude of a difference between an input (source data) that is the source of generating an AX and the AX. However, the risk assessment device 200 may be configured to calculate comparison results between a difference degree and a plurality of predetermined thresholds as information indicating the risk, and output the calculated result, for example. As described above, the risk assessment device 200 may be configured to output a value based on the difference degree.

### <Hardware Configuration>

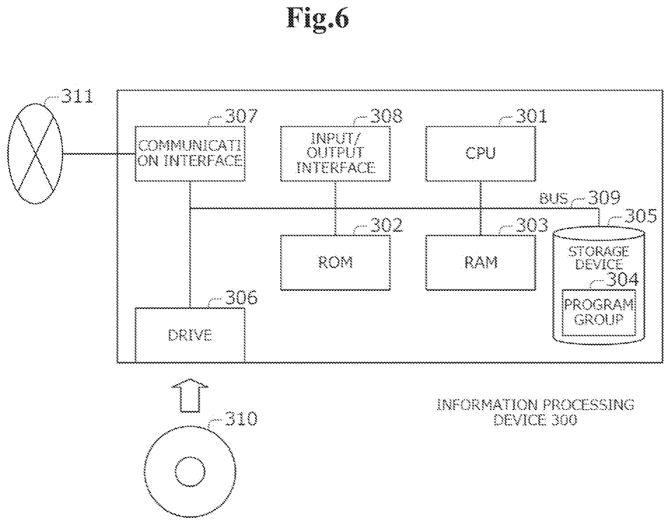

The constituent elements of the AX generation device 100 and the risk assessment device 200, described in the first and second exemplary embodiments, show blocks in function units. Part or whole of the constituent elements held by the AX generation device 100 and the risk assessment device 200 can be realized by any combinations of an information processing device 300 as illustrated in FIG. 6 and a program, for example. FIG. 6 is a block diagram illustrating an exemplary hardware configuration of the information processing device 300 that realizes the constituent elements of the AX generation device 100 and the risk assessment device 200. As an example, the information processing device 300 may include the following configurations:
CPU 301
ROM (Read Only Memory) 302
RAM (Random Access Memory) 303
Program group 304 to be downloaded to the RAM 303
Storage device 305 in which the program group 304 is stored
Drive 306 that performs reading and writing on the storage medium 310 outside the information processing device 300
Communication interface 307 connecting with the communication network 311 outside the information processing device 300
Input/output interface 308 for performing data input/output
Bus 309 connecting the constituent elements

The constituent elements of the AX generation device 100 and the risk assessment device 200 in the embodiments described above can be realized by acquisition and execution, by the CPU 301, of the program group 304 for implementing those functions. The program group 304 for implementing the functions of the constituent elements of the AX generation device 100 and the risk assessment device 200 is, for example, stored on the storage device 305 or the ROM 302 in advance, and is downloaded to the RAM 303 by the CPU 301 as required. Note that the program group 304 may be provided to the CPU 301 via the communication network 311, or may be stored on a storage medium 310 in advance and read out by the drive 306 and supplied to the CPU 301.

Note that FIG. 6 illustrates an exemplary configuration of the information processing device 300. The configuration of the information processing device 300 is not limited to that described above. For example, the information processing device 300 may be configured of part of the configuration described above, such as not including the drive 306. Further, the constituent elements of the AX generation device 100 and the risk assessment device 200 may be configured of one information processing device or may be configured of a plurality of information processing devices.

### Third Exemplary Embodiment

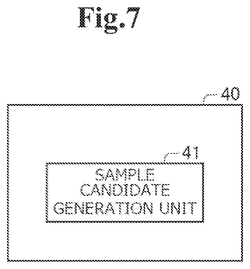

Next, a third exemplary embodiment of the present invention will be described with reference to FIG. 7. In the third exemplary embodiment, the overall configuration of an information processing device 40 will be described.

FIG. 7 illustrates an exemplary configuration of the information processing device 40. Referring to FIG. 7, the information processing device 40 has a sample candidate generation unit 41, for example.

For example, the information processing device 40 includes an arithmetic unit such as a CPU and a storage unit. For example, in the information processing device 40, the arithmetic unit executes a program stored in the storage unit, whereby the various processing units described above are implemented.

The sample candidate generation unit 41 generates sample candidates that induce erroneous authentication as a target class that is a class inducing erroneous authentication, on the basis of the similarity degree with the data belonging to the target class in the template that is data registered in advance and the similarity degree with the data not belonging to the target class in the template.

As described above, the information processing device 40 includes the sample candidate generation unit 41. With this configuration, the sample candidate generation unit 41 can generate a plurality of sample candidates, on the basis of the similarity degree with the data belonging to the target class and the similarity degree with the data not belonging to the target class in the template. Consequently, the sample candidate generation unit 41 can generate sample candidates while considering not only the data belonging to the target class but also the data not belonging to the target class. That is, it is possible to generate more appropriate sample candidates in which erroneous authentication can be succeeded.

Further, the information processing device 40 described above can be realized by incorporating a predetermined program in the information processing device 40. Specifically, a storage medium on which a program that is another embodiment of the present invention is stored is a computer-readable storage device storing a program for realizing, on an information processing device, the sample candidate generation unit 41 that generates sample candidates that induce erroneous authentication as a target class, on the basis of the similarity degree with the data belonging to a target class that is a class inducing erroneous authentication in the template that is data registered in advance, and the similarity degree with the data not belonging to the target class in the template.

Further, an information processing method performed by the information processing device 40 described above is a method including, by the information processing device, generating sample candidates that induce erroneous authentication as a target class, on the basis of the similarity degree with the data belonging to a target class that is a class inducing erroneous authentication in the template that is data registered in advance, and the similarity degree with the data not belonging to the target class in the template.

The invention of a storage medium or an information processing method, having the above-described configuration, exhibits the same actions and effects as those of the information processing device 40. Therefore, the above-described objection of the present invention can be achieved by such an invention.

### <Supplementary Notes>

The whole or part of the exemplary embodiments disclosed above can be described as the following supplementary notes. Hereinafter, the outlines of an information processing device and the like of the present invention will be described. However, the present invention is not limited to the configurations described below.
(Supplementary Note 1)

An information processing device comprising

a sample candidate generation unit that generates a sample candidate to be authenticated to belong to a target class that is a class inducing erroneous authentication, from source data belonging to a class other than the target class, on a basis of a similarity degree with data belonging to the target class in a template that is data registered in advance and a similarity degree with data not belonging to the target class in the template.
(Supplementary Note 2)

The information processing device according to supplementary note 1, wherein

the sample candidate generation unit generates the sample candidate by solving an optimization problem of obtaining a value having a larger similarity degree with the data belonging to the target class and a smaller similarity degree with the data not belonging to the target class.
(Supplementary Note 3)

The information processing device according to supplementary note 2, wherein

the sample candidate generation unit generates the sample candidate by transforming the optimization problem to a minimization problem of an objective function and searching for a solution.
(Supplementary Note 4)

The information processing device according to supplementary note 3, further comprising:

a difference degree calculation unit that calculates a difference degree indicating magnitude of a difference between the source data and the sample candidate, the source data being data serving as a source of generating the sample candidate; and

an erroneous authentication degree calculation unit that calculates an erroneous authentication degree that is a function of minimization in the optimization problem, wherein

the sample candidate generation unit generates the sample candidate by solving the objective function represented with use of a calculation result by the difference degree calculation unit, a calculation result by the erroneous authentication degree calculation unit, and a given parameter.
(Supplementary Note 5)

The information processing device according to supplementary note 4, wherein

a plurality of the parameters are included, and

the sample candidate generation unit generates the sample candidate corresponding to each of the parameters.
(Supplementary Note 6)

The information processing device according to supplementary note 4 or 5, wherein

the sample candidate generation unit determines an initial point, and generates a plurality of the sample candidates by changing the initial point.
(Supplementary Note 7)

The information processing device according to any one of supplementary notes 1 to 6, further comprising

a sample identifying unit that identifies a sample in which erroneous authentication to the target class succeeds, among a plurality of the sample candidates generated by the sample candidate generation unit.
(Supplementary Note 8)

The information processing device according to supplementary note 7, wherein

the sample identifying unit selects, from among the identified samples, a sample having a minimum difference degree, the difference degree being a difference from the source data that is data serving as a source of generating the sample.
(Supplementary Note 9)

The information processing device according to supplementary note 8, wherein

the sample identifying unit outputs the selected sample and the difference degree between the selected sample and the source data.
(Supplementary Note 10)

An information processing method comprising,

by an information processing device, generating a sample candidate to be authenticated to belong to a target class that is a class inducing erroneous authentication, from source data belonging to a class other than the target class, on a basis of a similarity degree with data belonging to the target class in a template that is data registered in advance and a similarity degree with data not belonging to the target class in the template.
(Supplementary Note 11)

The information processing method according to supplementary note 10, wherein

the generating the sample candidate includes generating the sample candidate by solving an optimization problem of obtaining a value having a larger similarity degree with the data belonging to the target class and a smaller similarity degree with the data not belonging to the target class.
(Supplementary Note 12)

The information processing method according to supplementary note 11, wherein

the generating the sample candidate includes generating the sample candidate by transforming the optimization problem to a minimization problem of an objective function and searching for a solution.
(Supplementary Note 13)

A computer-readable storage medium storing a program for realizing, on an information processing device,

a sample candidate generation unit that generates a sample candidate to be authenticated to belong to a target class that is a class inducing erroneous authentication, from source data belonging to a class other than the target class, on a basis of a similarity degree with data belonging to the target class in a template that is data registered in advance and a similarity degree with data not belonging to the target class in the template.

It should be noted that the program described in the respective exemplary embodiments and the supplementary notes may be stored in a storage device or stored on a computer-readable storage medium. The storage medium is a portable medium such as a flexible disk, an optical disk, a magneto-optical disk, or a semiconductor memory, for example.

While the present invention has been described with reference to the respective exemplary embodiments described above, the present invention is not limited to the above-described embodiments. The form and details of the present invention can be changed within the scope of the present invention in various manners that can be understood by those skilled in the art.

### REFERENCE SIGNS LIST

100 AX generation device
102 AX candidate generation unit
104 objective function value calculation unit
106 difference degree calculation unit
108 erroneous authentication degree calculation unit
110 AX identifying unit
200 risk assessment device
210 difference minimum AX identifying unit
300 information processing device
301 CPU
302 ROM
303 RAM
304 program group
305 storage device
306 drive
307 communication interface
308 input/output interface
309 bus
310 storage medium
311 communication network
40 information processing device
41 sample candidate generation unit

What is claimed is:

1. An information processing device comprising
a sample candidate generation unit that generates a sample candidate to be authenticated to belong to a target class that is a class inducing erroneous authentication, from source data belonging to a class other than the target class, on a basis of a similarity degree with data belonging to the target class in a template that is data registered in advance and a similarity degree with data not belonging to the target class in the template.

2. The information processing device according to claim 1, wherein
the sample candidate generation unit generates the sample candidate by solving an optimization problem of obtaining a value having a larger similarity degree with the data belonging to the target class and a smaller similarity degree with the data not belonging to the target class.

3. The information processing device according to claim 2, wherein
the sample candidate generation unit generates the sample candidate by transforming the optimization problem to a minimization problem of an objective function and searching for a solution.

4. The information processing device according to claim 3, further comprising:
a difference degree calculation unit that calculates a difference degree indicating magnitude of a difference between the source data and the sample candidate, the source data being data serving as a source of generating the sample candidate; and
an erroneous authentication degree calculation unit that calculates an erroneous authentication degree that is a function of minimization in the optimization problem, wherein
the sample candidate generation unit generates the sample candidate by solving the objective function represented with use of a calculation result by the difference degree calculation unit, a calculation result by the erroneous authentication degree calculation unit, and a given parameter.

5. The information processing device according to claim 4, wherein
a plurality of the parameters are included, and
the sample candidate generation unit generates the sample candidate corresponding to each of the parameters.

6. The information processing device according to claim 4, wherein
the sample candidate generation unit determines an initial point, and generates a plurality of the sample candidates by changing the initial point.

7. The information processing device according to claim 1, further comprising
a sample identifying unit that identifies a sample in which erroneous authentication to the target class succeeds, among a plurality of the sample candidates generated by the sample candidate generation unit.

8. The information processing device according to claim 7, wherein
the sample identifying unit selects, from among the identified samples, a sample having a minimum difference degree, the difference degree being a difference from the source data that is data serving as a source of generating the sample.

9. The information processing device according to claim 8, wherein
the sample identifying unit outputs the selected sample and the difference degree between the selected sample and the source data.

10. An information processing method comprising,
by an information processing device, generating a sample candidate to be authenticated to belong to a target class that is a class inducing erroneous authentication, from source data belonging to a class other than the target class, on a basis of a similarity degree with data belonging to the target class in a template that is data registered in advance and a similarity degree with data not belonging to the target class in the template.

11. The information processing method according to claim 10, wherein
the generating the sample candidate includes generating the sample candidate by solving an optimization problem of obtaining a value having a larger similarity degree with the data belonging to the target class and a smaller similarity degree with the data not belonging to the target class.

12. The information processing method according to claim 11, wherein
the generating the sample candidate includes generating the sample candidate by transforming the optimization problem to a minimization problem of an objective function and searching for a solution.

13. A non-transitory computer-readable storage medium storing a program comprising instructions for realizing, on an information processing device,
a sample candidate generation unit that generates a sample candidate to be authenticated to belong to a target class that is a class inducing erroneous authentication, from source data belonging to a class other than the target class, on a basis of a similarity degree with data belonging to the target class in a template that is data registered in advance and a similarity degree with data not belonging to the target class in the template.
